(19) United States
(12) Patent Application Publication
(10) Pub. No.: US 2006/0062976 A1
(43) Pub. Date: Mar. 23, 2006

(54) Printed circuit board material for embedded passive devices

(75) Inventors: Seung Hyun Sohn, Suwon (KR); Hyo Soon Shin, Yongin (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 10/995,826

(22) Filed: Nov. 24, 2004

(30) Foreign Application Priority Data
Sep. 23, 2004 (KR) 2004-76557

(51) Int. Cl. B32B 3/00; B32B 5/16

(52) U.S. Cl. 428/209; 428/320.2; 428/328

(57) ABSTRACT

A printed circuit board material for embedded passive devices, which has excellent electromagnetic properties and reliability is provided. The invention provides a printed circuit board material comprises: a conductive copper foil layer; a resin bonding layer formed on the conductive layer and including above 70-100 vol % of resin and 0-30 vol % of filler; and a functional layer formed on the resin bonding layer and including resin and filler. The printed circuit board material has the resin bonding layer interposed between the copper foil layer and the functional layer. Thus, even when the content of fillers in the functional layer is increased, the adhesion strength between the conductive layer and the functional layer is ensured without deteriorating the properties of the functional layer, such as dielectric and magnetic properties.

### RELATED APPLICATIONS

The present application is based on, and claims priority from, Korean Application Number 2004-76557, filed Sep. 23, 2004, the disclosure of which is hereby incorporated by reference her ein in its entirety.

### BACKGROUND OF THE INVENTION

1. Field of the Invention

The present invention relates to a printed circuit board (PCB) material for embedded passive devices, and more particularly to a printed circuit board material for embedded passive devices, which has excellent electromagnetic properties and reliability.

2. Description of the Prior Art

As electronic products have become smaller in size and more common and functional, embedded passive device technology for embedding passive devices in PCBs has recently been introduced. This technology generally utilizes a material which is either in a printed paste form or in a form where dielectric (or magnetic) fillers capable of realizing the desired characteristics are dispersed in an insulating layer resin. This technology allows improvements in characteristics, such as a reduction in product size, a reduction in noise and the number of inferior products caused by solder connections, and a reduction in high frequency noise.

In PCB materials for an embedded passive device (EPD) which are produced by dispersing dielectric (or magnetic) fillers, an increase in the amount of the fillers shows an increase in the desired dielectric and magnetic properties, but causes a reduction in peel strength with a metal (e.g., copper) foil due to a relative reduction in the amount of adhesive resin. This causes reliability problems, such as the occurrence of peeling after production.

Furthermore, according to the recent introduction of Pb-free solder, an increase in the thermal resistance of resin is required. However, an increase in the thermal resistance of resin generally causes the problem of a reduction in peel strength. As copper foils, not only standard Cu foils but also low profile (LP) or very low profile (VLP) Cu foils with low roughness, such as reverse-treated (RT) or double-treated (DT) Cu foils, are frequently used for their ability the achieve fine patterns and the uniformity of their dielectric characteristics. A reduction in the roughness of such metal foils improves the characteristic uniformity and etching properties, but causes the problem of a reduction in adhesion.

FIGS. 1a and 1b show the structure of resin-coated copper (RCC) foils according to the prior art. As shown in FIGS. 1a and 1b, the resin-coated copper foil has been produced either in a two-layer structure (FIG. 1a) by coating a mixture of filler and resin on a conductive copper foil layer and thermally treating the coated mixture, or in a three-layer structure (FIG. 1b) by coating a mixture of filler and resin on a conductive copper foil layer, thermally treating the coated mixture layer and forming a resin bonding layer on the coated mixture layer. The three-layer RCC foil having the resin bonding layer on the filler/resin mixture layer overcomes the problem of adhesion to a surface to be adhered, which is problematic in the prior RCC foil, but both the two-layer RCC foil and the three-layer RCC foil still have the above-described problem of low peel strength between the copper foil and the resin/filler mixture layer.

Meanwhile, in the prior art on high-dielectric capacitors or printed circuit boards, US Laid-Open Patent Application No. 2002-48137 and U.S. Pat. No. 6,618,238 disclose a two-layer embedded capacitor comprising a conductive metal foil layer and a dielectric layer made of filler and resin, and a capacitor comprising a conductive layer, a dielectric layer and a resin bonding layer which are sequentially deposited. However, such patents do not include any disclosure on the improvement of peel strength.

Moreover, Japanese Patent Laid-Open Publication No. 2000-208945 discloses a condenser-embedded wiring board comprising an electrode layer and a dielectric layer, in which the development of short circuits due to contact between the electrode layer and the dielectric layer is prevented, as well as a production method thereof. However, it also does not include any disclosure on an increase in the adhesion between the electrode layer and the dielectric layer.

### SUMMARY OF THE INVENTION

Accordingly, an object of the present invention is to provide a printed circuit board material for embedded passive devices, which has excellent electromagnetic properties and reliability.

Another object of the present invention is to provide a printed circuit board material for embedded passive devices, which includes a resin bonding layer interposed between a conductive layer and a functional layer and is excellent in dielectric and magnetic properties and adhesion strength.

In one aspect, the present invention provides a printed circuit board material for embedded passive devices, which comprises: a conductive copper foil layer; a resin bonding layer formed on the conductive layer and including above 70-100 vol % of resin and 0-30 vol % of filler; and a functional layer formed on the resin bonding layer and including resin and filler.

In another aspect, the present invention provides a printed circuit board material for embedded passive devices, which comprises a conductive copper foil layer; a first resin bonding layer formed on the conductive layer and including above 70-100 vol % of resin and 0-30 vol % of filler; a functional layer formed on the resin bonding layer and including resin and filler; a second resin bonding layer formed on the functional layer and including above 70-100 vol % of resins and 0-30 vol % of fillers; and a conductive copper foil layer formed on the second resin bonding layer.

### BRIEF DESCRIPTION OF THE DRAWINGS

The above and other objects, features and advantages of the present invention will be more clearly understood from the following detailed description taken in conjunction with the accompanying drawings, in which:

FIGS. 1a and 1b are side cross-sectional views of the prior printed circuit board materials for embedded passive devices;

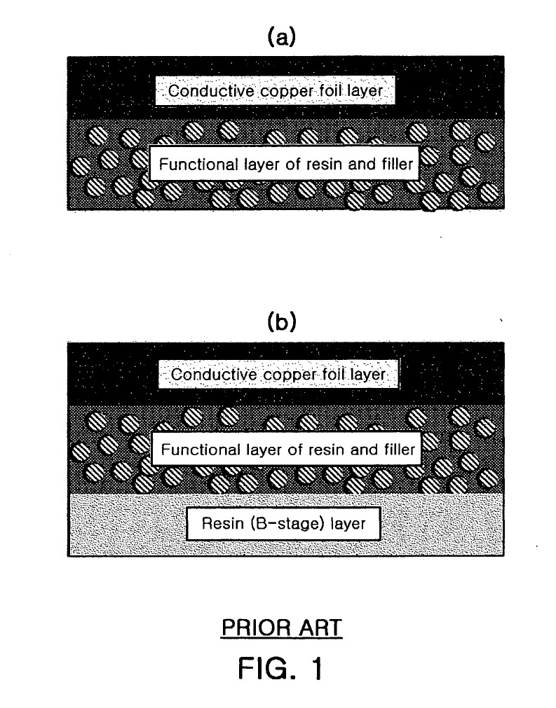

FIG. 2 is a side cross-sectional view showing a process for producing printed circuit board materials for embedded passive devices and printed circuit board materials produced thereby, in which FIG. 2b is a side cross-sectional view of a RCC foil, and FIG. 2c is a side cross-sectional view of a CCL foil;

FIG. 3 is a graphic diagram showing changes in electrical property and peel strength with a change in the filler content of a functional layer in PCB of Comparative Example 1;

FIG. 4 is a graphic diagram showing a change in the peel strength of printed circuit board materials produced in Comparative Example 1 and Inventive Example 1; and

FIG. 5 is a graphic diagram showing a change in the peel strength of printed circuit board materials produced in Comparative Example 2 and Inventive Example 2.

### DETAILED DESCRIPTION OF THE INVENTION

This invention will be described in further detail by way of example with reference to the accompanying drawings.

The present invention provides a sandwich-type printed circuit board for embedded passive devices, in which a resin bonding layer is interposed between a conductive metal layer and a functional layer including resin and filler. The inventive printed circuit board material for embedded passive devices, which has the resin bonding layer, is excellent not only in electromagnetic properties, such as dielectric and magnetic properties, but also in peel strength.

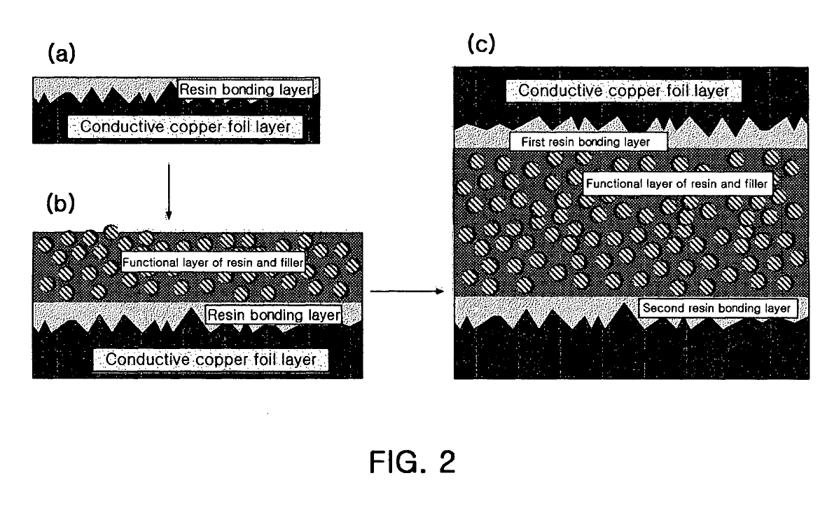

FIG. 2 shows a process for producing printed circuit board materials for embedded passive devices, according to the present invention, and printed circuit board materials produced thereby. Hereinafter, description will be made with reference to FIG. 2. As shown in FIG. 2, the inventive printed circuit board material for embedded passive devices comprises a conductive copper foil layer, a resin bonding layer, and a functional layer including resin and filler.

The functional layer is generally made of resin and filler. Dielectric filler, magnetic filler or hollow-type filler is selected for the filler depending on the properties required for the PCB, such as dielectric, magnetic, or low-dielectric properties. Also, in order to increase the desired properties, the amount of the selected filler may be increased. However, an increase in the amount of the filler in the functional layer leads to a relative reduction in the amount of the resin, thus causing a problem in that the adhesion strength between the conductive metal layer and the functional layer is reduced so that the conductive layer is easily peeled off.

Also, this reduction of the adhesion strength between the conductive layer and the functional layer results in a reduction in resistance to heat applied during the production of printed circuit boards, thus causing problems in the handling and reliability of the PCB.

Furthermore, as a thinner and smoother conductive copper foil that can achieve fine patterns and that has uniform dielectric properties is required, the adhesion strength between the conductive layer and the functional layer is further reduced so that the conductive layer is easily peeled off.

For these reasons, the present invention provides a PCB material which has a resin bonding layer interposed between the conductive layer and the functional layer such that requirements for excellent dielectric and magnetic properties and peel strength are all satisfied. Due to the resin bonding layer between the conductive layer and the functional layer, the bonding strength between the conductive layer and the functional layer is increased.

The conductive layer in the inventive PCB material may be made of any copper foil which is generally used in the production of PCB materials. Examples of the copper foil which can be used in the present invention include, but are not limited to, electrolytic copper foils, such as standard type foils (STD, Rz of 5-10 μm) or very low profile foils (VLP, Rz of 2-5 μm), and rolled copper foils (Rz of less than 1 μm).

The present invention aims to increase the adhesion strength between the conductive copper foil layer and the functional layer, and is particularly useful for application to VLP-type foils or rolled copper foils which have low adhesion to the functional layer due to a low surface roughness of less than 5 μm.

As shown in (a) of FIG. 2, in the inventive printed circuit board material, a resin bonding layer is formed on one surface of the conductive copper foil layer so as to increase the bonding strength between the conductive layer and the functional layer.

The resin bonding layer may be made of 0-30 vol % of filler and above 70-100 vol % of resin. The resin bonding layer is interposed between the functional layer containing large amounts of filler and the conductive layer so as to increase the adhesion strength therebetween. A resin content of equal or less than 70 vol % in the resin bonding layer undesirably leads to a relative increase in the content of the fillers, so that it does not show the effect of a sufficient increase in the adhesion strength between the two layers. Also, if the resin bonding layer contains the filler within a content range which does not cause a reduction in adhesion, particularly in the amount of equal or less than 30 vol %, it will show an increase not only in adhesion but also in dielectric or magnetic properties required in the functional layer. Thus, the resin bonding layer may contain the filler in an amount which does not cause a reduction in adhesion.

An increase in the thickness of the resin bonding layer leads to an increase in the total thickness of insulating layers, so that capacitance can be reduced. For this reason, the resin bonding layer is preferably formed to the smallest possible thickness, and this may be likewise applied even when the realization of low-dielectric properties is required. Also, even when filler, such as ferrite, is used to realize inductance, an increase in the thickness of the resin bonding layer can cause the deterioration of magnetic properties, and thus it is preferable that the resin bonding layer be formed in the smallest possible thickness. Accordingly, in the present invention, the resin bonding layer is preferably formed in a thickness of equal or less than 10 μm such that it provides sufficient adhesion strength between the conductive layer and the functional layer and does not cause a reduction in dielectric and/or magnetic properties.

The resin bonding layer can be formed on the conductive copper foil layer by a coating method which is generally used in this technical field. Examples of the coating method include, but are not limited to, comma coating and die casting methods.

After forming the resin bonding layer, as shown in b of FIG. 2, the resin bonding layer is subjected to B-stage semi-curing. On the semi-cured resin bonding layer, a functional layer is then coated so as to produce a resin-coated copper (RCC) foil.

The functional layer is made of resin and filler. A functional layer containing resin and filler in a given mixing ratio can be used in the present invention. Although the mixing ratio between resin and filler in the functional layer is not specifically limited and the dielectric and/or magnetic character is increased in the event of the functional layer containing a large amount of filler, the present invention aims to increase the adhesion strength and thus is particularly advantageous to increase adhesion, when it is applied to a functional layer containing large amounts of filler.

For example, when the present invention is applied to a functional layer containing 30-99 vol % of filler and 1-70 vol % of resin, it significantly increases peel strength.

The thickness of the functional layer is not specifically limited, and may be suitably selected from within a thickness range which is generally applied in this technical field.

The resins which can be used in the resin bonding layer and the functional layer include thermosetting resins and thermoplastic resins. Examples of the thermosetting resins include, but are not limited to, epoxy resin, phenol resin, polyimide resin, melamine resin, cyanate resin, bismaleimide resin and diamine addition polymers thereof, and benzocyclobutene (BCB). Such thermosetting resins may be used alone or in a mixture of two or more.

Examples of the thermoplastic resins include, but are not limited to, polyester, polyethylene terephthalate (PET), polyamide (PA), polycarbonate (PC), and polybutylene terephthalate (PBT). Such thermoplastic resins may be used alone or in a mixture of two or more.

Any resin may be used as the resin as long as it has sufficient resistance to heat applied when processing printed circuit boards (e.g., soldering at 280° C.). Also, in the resin bonding layer and the functional layer, the same or different resins may be used.

As the resin, epoxy resins are most preferable in view of heat resistance, peel strength, and the like.

As the epoxy resins, those generally known in the art may be used. Examples of the epoxy resins include, but are not limited to, epoxy compounds containing aromatic rings, such as phenol novolac epoxy resin, cresol novolac epoxy resin, biphenyl epoxy resin, biphenyl novolac epoxy resin, tris hydroxyphenyl methane epoxy resin, tetra phenyl ethane epoxy resin, bisphenol A novolac epoxy resin, bisphenol A epoxy resin, and dicyclopentadiene phenol epoxy resin, cycloaliphatic epoxy resin, and halogen-containing epoxy resin, such as tetrabromobisphenol A epoxy resin and multi-functional epoxy resin. Such epoxy resins may be used alone or in a mixture of two or more.

The filler in the resin bonding layer and the functional layer may be selected from dielectric filler, magnetic filler and hollow-type filler depending on functions required in the functional layers, such as dielectric, magnetic and low-dielectric properties.

Examples of the dielectric filler which can be used in the present invention include metal powder, resin having a metal layer formed on the surface thereof, ceramic powder and high-dielectric fillers. Examples of the metal powder include Cu, Al, As, Au, Ag, Pd, Mo, and W, and examples of the high-dielectric filler include TiO₂, BaTiO₃, SrTiO₃, CaTiO₃, MgTiO₃, PbTiO₃, KNbO₃, NaTiO₃, KTaO₃, and RbTaO₃.

Semi-conductive filler or semi-conductive filler having an insulating layer formed on the surface thereof may also be used as the dielectric filler. Examples of the semi-conductive filler may include zinc oxide. Preferred examples of insulating material which is used to form the insulating layer on the surface of the semi-conductive filler include, but are not limited to, BaTiO₃ and Pb-based ferroelectrics, since they can form the insulting layer without causing a great reduction in the dielectric constant of the semi-conductive fillers.

The insulating layer on the surface of the semi-conductive filler can be formed either by coating an insulating material on the surface of the semi-conductive filler and then thermally treating the coated material or by thermally treating the semi-conductive filler so as to oxidize the surface of the filler.

The insulating material is coated on the surface of the semi-conductive filler in an amount of 70-95 vol %, and preferably 80-90 vol %, based on the volume of the semi-conductive filler. If the content of the insulating material is less than 70 vol %, semi-conductive filler powder does not get completely wet or coated by liquid insulating material and if the content of the insulating material is more than 95 vol %, the crystallinity of the coated filler powder will be reduced.

Either the thermal treatment of the insulating material coated on the semi-conductive filler or the thermal treatment of the semi-conductive filler is performed under an oxidation atmosphere at 700-1,300° C. for 30 minutes to 2 hours, and preferably 30 minutes to 1 hour. If the thermal treatment of the insulating material is performed at less than 700° C., the insulating material will not be sufficiently dispersed into the vacancy of the semi-conductive filler, and if it is performed at more than 1,300° C., compaction of the insulating material will occur, thus causing a change in physical properties. If the thermal treatment time is shorter than 30 minutes, the insulating layer will not be sufficiently formed, and if it is longer than 2 hours, the insulating layer becomes thick, resulting in a reduction in dielectric constant.

As the dielectric filler, semi-conductive ferroelectrics may also be used.

The semi-conductive ferroelectrics can be obtained either by thermally treating ferroelectrics or by adding a doping additive to the surface of ferroelectrics followed by thermal treatment. Examples of the ferroelectrics which can be used in the present invention include Pb-based ferroelectrics, such as BaTiO₃, PbTiO₃, PMN—PT, SrTiO₃, CaTiO₃, and MgTiO₃. Such ferroelectrics may be used alone or in a mixture of two or more.

Examples of the doping additives which can be used in the present invention include 2+, 3+ and 5+ oxides of Mn, Mg, Sr, Ca, Y, or Nb, and oxides of lanthanum-group elements, such as Ce, Dy, Ho, Yb or Nd. Such doping additives may be used alone or in a mixture of two or more.

The thermal treatment of the ferroelectrics can be performed under an oxidation, reduction or vacuum atmosphere at 800-1,300° C., and preferably 1,000-1,300° C., for 30 minutes to 2 hours. This results in an increase in oxygen vacancy, thus making the ferroelectrics semi-conductive.

If the thermal treatment of the ferroelectrics is performed at a temperature lower than 800° C. or for less than 30 minutes, energy required for the formation of oxygen vacancy will be insufficient, and if it is performed at a temperature higher than 1,300° C. or for more than 2 hours, grain growth will occur, resulting in a reduction in dielectric constant.

If magnetic properties are to be realized, metal fillers, such as Ni, Cu and Fe, or ferrite fillers, such as NiCuZn ferrite or MnZn ferrite, can be used as magnetic fillers.

Meanwhile, if a high frequency board material having low-dielectric properties is to be realized, hollow-type polymer fillers may be used as fillers. Alternatively, the functional layer may be made in a form where air is uniformly dispersed within resin constituting the functional layer. The polymer of the hollow-type polymer fillers may be a polymer with heat resistance, for example, a resin used in the resin bonding layers and the functional layer.

If fillers forming the resin bonding layer and the functional layer show the same properties (dielectric or magnetic properties), the same or different kinds of fillers may be used.

If necessary, the resin bonding layer and the functional layer may contain a curing agent or a curing accelerator, which is generally used in the art.

The fillers used in the present invention preferably have a particle diameter of less than 1 μm such that they are uniformly dispersed in the resin bonding layer and the functional layer.

Two of the RCC foils produced as described above are laminated on each other in such a manner that the functional layers face each other. The laminated structure is subjected to C-stage pressing and curing, thus producing a copper clad laminate (CCL) as shown in (c) of FIG. 2, which is used as a PCB material for embedded passive devices. The CCL shown in (c) of FIG. 2 has two (first and second) resin bonding layers.

Hereinafter, the present invention will be described in detail by examples.

### COMPARATIVE EXAMPLE 1

In this Comparative Example, printed circuit board material samples produced according to the prior art were measured for changes in electrical properties and peel strength of a printed circuit board with a change in the content of fillers in a functional layer. The printed circuit board samples used for the measurement of electrical properties and peel strength were produced in the following manner.

On one surface of an STD copper foil with a roughness of 5 μm and a width of 450 mm, a dielectric layer was coated in a thickness of 20 μm by a comma coating method. Then, the coated dielectric layer was subjected to B-stage semi-curing at 150-170° C. for 1-5 minutes, thus producing a RCC foil. Then, two pieces of the RCC foil produced as described above were laminated to each other in such a manner that the dielectric layers faced each other. Then, the laminated foils were pressed at 170° C. under a pressure of 100 kgf/cm², thus producing a copper clad laminate (CCL).

The functional layer was formed with varying contents (10-90 wt %) of barium titanate (BaTiO₃) and varying contents (10-90 wt %) of bisphenol A epoxy resin. Also, as the resin curing agent, dicyandiamide(DICY) was used at 2.6 weight parts per 100 weight parts of the resin, and as the curing accelerator, 2-methylimidazole (2MI) was used at 0.14 weight parts per 100 weight parts of the resin.

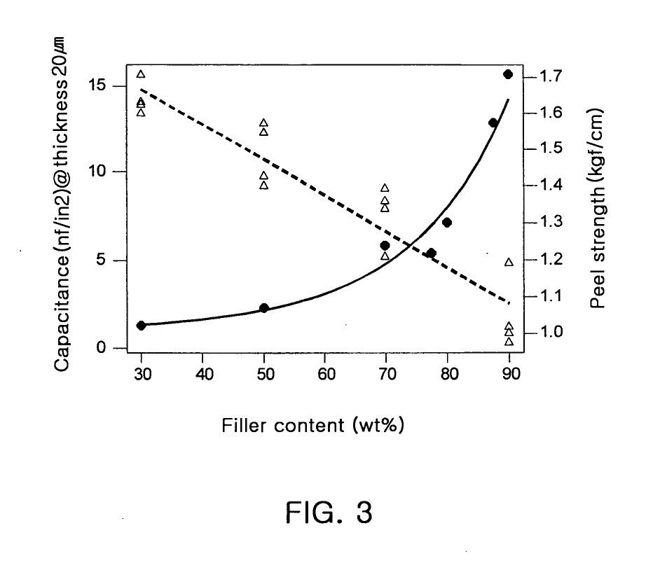

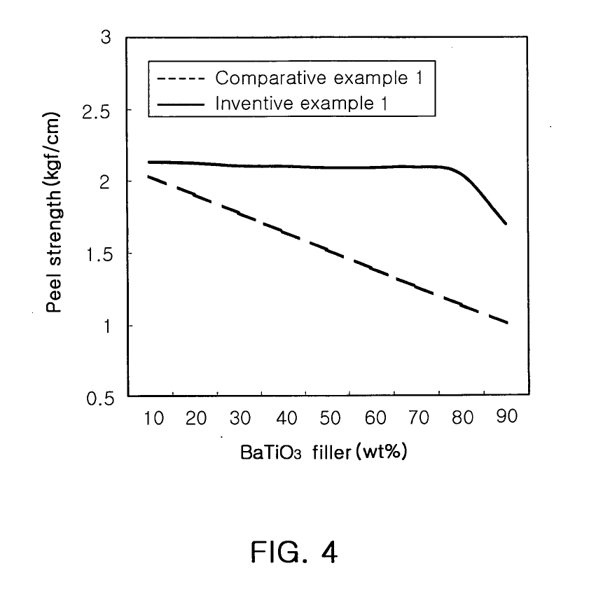

An etch-resistant tape was attached to the surface of the CCL produced as described above. Then, the CCL was dipped in nitric acid etchant so as to etch out the copper foil. Then, tensile strength upon removal of the etch-resistant tape was measured according to IPC TM-650-2.4.8 using a Zwick universal testing machine (UTM), thus measuring peel strength. The measured peel strengths are shown in Table 1 and FIGS. 3 and 4.

Capacitance of the CCP was measured according to IPC TM-650-2.5.5.1 and shown in FIG. 3.

As evident from Table 1 and FIGS. 3 and 4, an increase in the content of the filler barium titanate in the dielectric layer showed an increase in capacitance but a reduction in peel strength.

### COMPARATIVE EXAMPLE 2

In this Comparative Example, printed circuit board material samples produced according to the prior art were measured for a change in peel strength of a printed circuit board with a change in the content of fillers in a dielectric layer.

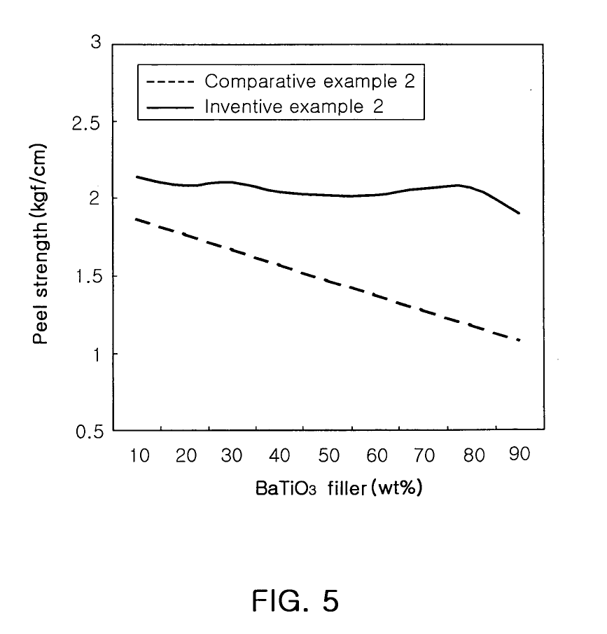

The samples used in this Comparative Example were produced in the same manner as in Comparative Example 1 except that a VLP copper foil with a roughness (Rz) of 3 μm was used as a copper foil, and a mixture of bisphenol A epoxy resin, bisphenol A novolac epoxy resin and brominated epoxy resin which had been mixed at a weight ratio of 1:3:1 was used as the resin in the dielectric layer. The produced samples were measured for peel strength, and the measurement results are shown in Table 2 and FIG. 5.

As evident from Table 2 and FIG. 5, an increase in the content of filler solids in the functional layer showed a reduction in peel strength.

### INVENTIVE EXAMPLE 1

This inventive example shows that printed circuit board material samples produced according to the inventive method maintain excellent peel strength regardless of a change in the content of fillers in a functional layer. The printed circuit board material samples used for the measurement of peel strength were produced in the following manner.

On one surface of an STD copper foil with a roughness of 5 μm and a width of 450 mm, a resin bonding layer made of bisphenol A epoxy resin was coated in a thickness of 10 μm by a comma coating method. The coated resin bonding layer was subjected to B-stage semi-curing at 150-170° C. for 1-5 minutes. Then, on the semi-cured resin bonding layer, a dielectric layer was coated in a thickness of 20 μm by a comma coating method, and subjected to B-stage semi-curing at 150-170° C. for 1-5 minutes, thus producing an RCC foil. Then, two pieces of the RCC foils produced as described above were laminated to each other in such a manner that the dielectric layers faced each other and then, pressed at 170° C. under a pressure of 100 kgf/cm², thus producing a copper clad laminate (CCL) having the resin bonding layer interposed between the conductive layer and the dielectric layer.

The dielectric layer was formed with varying contents (10-90 wt %) of barium titanate (BaTiO₃) and varying contents (10-90 wt %) of bisphenol A epoxy resin.

Also, as the resin curing agent, dicyandiamide (DICY) was used in the amount of 2.6 weight parts per 100 weight parts of the resin, and as the curing accelerator, 2-methylimidazole (2MI) was used in the amount of 0.14 weight parts per 100 weight parts of the resin.

An etch-resistant tape was attached to the surface of the CCL produced as described above. Then, the CCL was dipped in nitric acid etchant so as to etch out the copper foil. Then, tensile strength upon removal of the etch-resistant tape was measured according to IPC TM-650-2.4.8 using a Zwick universal testing machine (UTM), thus measuring peel strength. The measurement results are shown in Table 1 and FIG. 4.

As evident from Table 1 and FIG. 4, the inventive samples showed excellent peel strength regardless of an increase in the content of the filler barium titanate in the dielectric layer.

TABLE 1
Comparison of peel strength between samples of
Comparative Example 1 and Inventive Example 1

| | Peel strength (kgf/cm) | |
|---|---|---|
| Filler solids (weight %) | Comparative Example 1 | Inventive Example 1 |
| 10 | 1.8619 | 2.133 |
| 20 | 1.7644 | 2.08 |
| 30 | 1.6669 | 2.1 |
| 40 | 1.5694 | 2.035 |
| 50 | 1.4719 | 2.016 |
| 60 | 1.3744 | 2.014 |
| 70 | 1.2769 | 2.058 |
| 80 | 1.1795 | 2.067 |
| 90 | 1.0820 | 1.897 |

### INVENTIVE EXAMPLE 2

This Inventive Example shows that printed circuit board material samples produced according to the inventive method maintain excellent peel strength regardless of a change in the content of fillers in a functional layer.

The samples used in Inventive Example 2 were produced in the same manner as in Inventive Example 1 except that a VLP copper foil with a roughness (Rz) of 3 μm was used as a copper foil, and a mixture of bisphenol A epoxy resin, bisphenol A novolac epoxy resin and brominated epoxy resin which had been mixed in a weight ratio of 1:3:1 was used as the resin in the resin bonding layer and dielectric layer. The produced samples were measured for peel strength, and the measurement results are shown in Table 2 and FIG. 5.

As evident from Table 2 and FIG. 5, the inventive samples showed excellent peel strength regardless of an increase in the content of the filler barium titanate in the dielectric layer.

TABLE 2
Comparison of peel strength between samples of
Comparative Example 2 and Inventive Example 2

| | Peel strength (kgf/cm) | |
|---|---|---|
| Filler solids (weight %) | Comparative Example 2 | Inventive Example 2 |
| 10 | 1.5319 | 1.633 |
| 20 | 1.4044 | 1.6258 |
| 30 | 1.2769 | 1.6064 |
| 40 | 1.1494 | 1.6015 |
| 50 | 1.0219 | 1.5906 |
| 60 | 0.8944 | 1.5914 |
| 70 | 0.7669 | 1.5958 |
| 80 | 0.6395 | 1.5467 |
| 90 | 0.5120 | 1.197 |

As described above, the inventive printed circuit board material has the resin bonding layer interposed between the copper foil layer and the functional layer. Thus, even when the content of fillers in the functional layer is increased, the adhesive strength between the conductive layer and the functional layer is ensured without deteriorating the properties of the functional layer, such as dielectric and magnetic properties.

1. A printed circuit board material for embedded passive devices, which comprises:
a conductive copper foil layer;
a resin bonding layer formed on the conductive layer, and including above 70-100 vol % of resin and 0-30 vol % of filler; and
a functional layer formed on the resin bonding layer, and including resin and filler.

2. A printed circuit board material for embedded passive devices, which comprises:
a conductive copper foil layer;
a first resin bonding layer formed on the conductive layer, and including above 70-100 vol % of resin and 0-30 vol % of filler;
a functional layer formed on the resin bonding layer, and including resin and filler;
a second resin bonding layer formed on the functional layer, and including above 70-100 vol % of resin and 0-30 vol % of filler; and
a conductive copper foil layer formed on the second resin bonding layer.

3. The printed circuit board material of claim 1, wherein the copper foil of the conductive layer is a very low profile (VLP)-type electrolytic copper foil or a rolled copper foil.

4. The printed circuit board material of claim 1, wherein the copper foil of the conductive layer has a roughness of less than 5 μm.

5. The printed circuit board material of claim 1, wherein each of the resin bonding layer, the first resin bonding layer and the second resin bonding layer has a thickness of equal or less than 10 μm.

6. The printed circuit board material of claim 1, wherein the functional layer is a dielectric layer, a magnetic layer or a low-dielectric layer.

7. The printed circuit board material of claim 1, wherein the functional layer comprises 30-99 vol % filler and 1-70 vol % resin.

8. The printed circuit board material of claim 6, wherein the dielectric layer contains at least one dielectric filler selected from the group consisting of metal powder, such as Cu, Al, As, Au, Ag, Pd, Mo, and W, TiO₂, BaTiO₃, SrTiO₃, CaTiO₃, MgTiO₃, PbTiO₃, KNbO₃, NaTiO₃, KTaO₃, RbTaO₃, and ZnO.

9. The printed circuit board material of claim 6, wherein the magnetic layer contains at least one magnetic filler selected from the group consisting of Ni, Cu, Fe, NiCuZn ferrite and MnZn ferrite.

10. The printed circuit board material of claim 6, wherein the low-dielectric layer either contains a hollow-type polymer filler or is a functional layer where air is uniformly dispersed in the resin constituting the low-dielectric layer.

11. The printed circuit board material of claim 1, wherein the resin of the resin bonding layer, the first resin bonding layer, the second resin bonding layer and the functional layer is selected from the group consisting of epoxy resin, phenol resin, polyimide resin, melamine resin, cyanate resin, bismaleimide resin and diamine addition polymers thereof, benzocyclobutene, polyester, polyethylene terephthalate, polyamide, polycarbonate, polybutylene terephthalate, and a mixture of two or more thereof.
